(19) United States
(12) Patent Application Publication
(10) Pub. No.: US 2022/0200386 A1
(43) Pub. Date: Jun. 23, 2022

(54) ASSEMBLY COMPRISING AN ELECTRIC MACHINE, AN INVERTER AND AN INTERCONNECTOR

(71) Applicant: VALEO EQUIPEMENTS ELECTRIQUES MOTEUR, Creteil Cedex (FR)

(72) Inventors: Khadija EL BARAKA, Creteil Cedex (FR); Svetislav JUGOVIC, Creteil Cedex (FR); Didier CANITROT, Creteil Cedex (FR)

(73) Assignee: VALEO EQUIPEMENTS ELECTRIQUES MOTEUR, Creteil Cedex (FR)

(21) Appl. No.: 17/644,193

(22) Filed: Dec. 14, 2021

(30) Foreign Application Priority Data
Dec. 18, 2020 (FR) 20 13611

(51) Int. Cl. H02K 3/50; H02K 7/08; H02K 9/06; H02K 9/22; H02K 11/33; B60L 53/20; B60K 1/00

(52) U.S. Cl. CPC H02K 3/50; H02K 7/085; H02K 9/06; B60K 2001/006; H02K 11/33; B60L 53/20; B60K 1/00; H02K 9/227

(57) ABSTRACT

An assembly includes a rotary electric machine, and an inverter electrically connected to the rotary electric machine. The inverter includes a plurality of power modules, each power module including a first and a second lateral wall, a heat sink having fins disposed on each of said lateral walls, and an electronic module for controlling the plurality of power modules. An interconnector has a first face to which the plurality of power modules are fixed perpendicularly with respect thereto. The power modules are all concentrated over an angular portion (α) of the interconnector, the predefined portion (α) being less than 360°.

The present invention relates to an assembly, in particular for a hybrid vehicle, having a rotary electric machine and an inverter between which an interconnector is interposed for electrically connecting the two parts.

The invention finds applications in the field of rotary electric machines for hybrid vehicles, in particular motor vehicles, and in particular in the field of high-power reversible electric machines that can operate in alternator mode and in motor mode and are coupled with a gearbox.

In a manner known per se, rotary electric machines have a stator and rotor that is secured to a shaft. The rotor may be secured to a driving and/or driven shaft and may belong to a rotary electric machine in the form of an alternator, an electric motor, or a reversible machine capable of operating in both modes.

In certain types of motor vehicle drive trains, a high-power reversible rotary electric machine is coupled to the gearbox of the vehicle or to an axle system of the motor vehicle. The electric machine is thus able to operate in an alternator mode to supply in particular energy to the battery and/or to the on-board network of the vehicle, and in a motor mode, not only to start the combustion engine but also to provide motive power to the vehicle, on its own or in combination with the combustion engine.

The stator is mounted in a casing configured to rotate the shaft for example via rolling bearings. The rotor has a body formed by a stack of laminations held in the form of a pack by means of a suitable fixing system. The rotor has poles formed, for example, by permanent magnets housed in cavities provided in the magnetic mass of the rotor. Alternatively, in an architecture known as a “salient-pole” architecture, the poles are formed by coils that are wound around arms of the rotor.

Furthermore, the stator has a body formed by a stack of thin laminations forming a ring, the inner face of which is provided with slots that are open towards the inside in order to receive phase windings. These windings pass through the slots of the body of the stator and form bundles that protrude on either side of the body of the stator. The phase windings are obtained, for example, from a continuous wire covered with enamel or from conductive elements in the form of pins that are joined together by welding. These windings are polyphase windings that are star- or delta-connected, the outputs of which are connected to an electronic control and/or power module.

The electronic control and power module, such as an inverter, feeds the winding via a polyphase current system, for example a three-phase or dual three-phase current system. An interconnector makes the connection between the inverter and the electric machine, in particular the phases of the stator, in order to provide an electrical connection between an incoming/outgoing signal of the electric machine and an incoming/outgoing signal of the inverter.

Such a solution is disclosed for example in the application U.S. Ser. No. 10/164,504. In this example, the power modules are disposed around the entire circumference of the interconnector, leaving little room for the control module and not making it possible to obtain a compact assembly.

The invention thus aims to provide an assembly comprising a rotary electric machine, an inverter and a compact interconnector.

The present invention aims to overcome these drawbacks effectively by providing an assembly, in particular for a hybrid vehicle, comprising:
a rotary electric machine having:
   means for generating a forced flow of a coolant flowing in the axial direction of the machine,
   a rotor centred on and fixed to a rotary shaft extending along an axis X,
   a stator that surrounds the rotor and is provided with a body and at least one winding having a plurality of phase inputs/outputs, and
   a rear bearing that is mounted at one end of the rotor and receives the shaft,
an inverter electrically connected to the rotary electric machine and having:
   a plurality of power modules, each power module comprising a wall with a first and a second face,
   a heat sink having fins associated with each of said lateral walls, and
   an electronic module for controlling the plurality of power modules,
an interconnector configured to connect the phases of the winding of the stator to the plurality of power modules and to connect the latter to the electronic control module, the interconnector having both a first face to which the plurality of power modules are fixed perpendicularly with respect thereto and a second face that is on the opposite side from said first face and oriented towards the rear bearing,
   wherein the power modules are all concentrated over an angular portion α of the interconnector, said predefined portion a being less than 360°, preferably less than 220°.

The invention thus makes it possible to obtain a compact assembly that frees up room for the other components of the assembly.

In the description and the claims, the terms “external” and “internal” and the orientations “axial” and “radial” will be used to denote elements of the rotor, of the stator and/or of the electric machine according to the definitions given in the description. By convention, the “radial” orientation is orthogonal to the axial orientation. Depending on the context, the axial orientation relates to the axis of rotation of the rotor, of the stator and/or of the electric machine. The “circumferential” orientation is orthogonal to the axial direction and orthogonal to the radial direction. The terms “external” and “internal” are used to define the relative position of one element with respect to another, with respect to the reference axis, an element close to the axis thus being described as internal as opposed to an external element situated radially at the periphery.

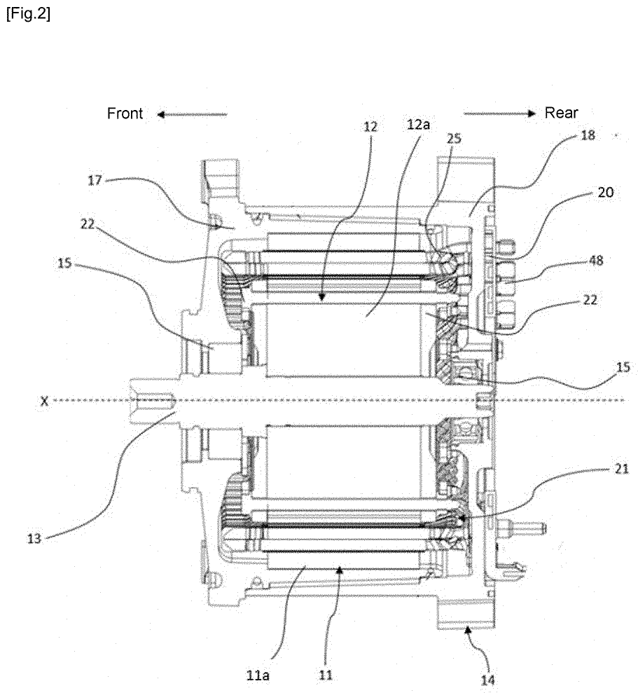

In the rest of the description, the orientation from the front to the rear of the electric machine corresponds to an orientation going from left to right in FIG. 2. Thus, a “front” element is understood to be an element situated at the splined end of the shaft of the machine and a “rear” element is understood to be an element situated on the opposite side, that is to say on the interconnector or inverter side.

According to one aspect of the invention, the first face of the interconnector has a predefined angular portion β that is able to receive said electronic control module, said angular portion β being equal to 360°-α.

According to one aspect of the invention, the plurality of power modules are distributed in at least two groups, each group being fixed to the first face of the interconnector independently of the other groups. Thus, when the electric machine is not in operation on account for example of a power module, all that is necessary is to disassemble the group in which the power module that is not operating is located in order to discard it and replace it with a new power module. It is thus not necessary to discard the entire electric machine or all the power modules when these are fixed together on the interconnector, and this makes maintenance easier.

Advantageously, a group may comprise a single power module, in which case there will be as many groups as there are power modules.

According to one aspect of the invention, each power module comprises a first end which faces the first face of the interconnector to which it is fixed and a second end on the opposite side to said first end, said second end not having any connection.

Preferably, each power module comprises a plurality of electronic power switches mounted on power tracks.

According to one aspect of the invention, the plurality of power modules are fixed to the first face of the interconnector via fixing means which also serve for the electrical connection between the power modules and the interconnector.

According to one aspect of the invention, the interconnector comprises overmoulded tracks B+ and B−. Preferably, the plurality of power modules are connected to the tracks B+ and/or B− by the first face of the interconnector.

According to one aspect of the invention, the fins form axially oriented channels through which the axial flow of coolant passes so as to effectively cool the power module over its entire axial extent.

The heat sink is preferably made of a highly conductive metal such as aluminium.

According to one aspect of the invention, the interconnector comprises openings which extend perpendicularly to the axis of rotation for the passage of the axial flow of coolant.

According to one aspect of the invention, the rear bearing comprises openings which extend perpendicularly to the axis of rotation for the passage of the axial flow of coolant, said openings being substantially aligned with the openings in the interconnector.

Preferably, the rear bearing comprises radial outlet apertures for the coolant. In a variant, the rear bearing may be free of radial fluid outlet apertures and in this case the flow of the coolant takes place by conduction (for example closed machine equipped with a water circuit).

According to one aspect of the invention, the power module comprises two aluminium parts disposed on either side of its lateral walls, in particular on the lateral walls of the heat sinks. These aluminium parts make it possible to improve the thermodynamics and stiffen the structure of the power module on which they are installed.

According to one aspect of the invention, the winding may be of the dual three-phase type.

According to one aspect of the invention, the inverter is offset axially from the electric machine. The electric machine and the inverter follow one another axially.

Advantageously, the rotor has a body formed by a stack of laminations held in the form of a pack by means of a suitable fixing system. The rotor has poles formed only by permanent magnets housed in cavities provided in the magnetic mass of the rotor. In such a way, the magnetic flux is created only by the permanent magnets and the rotor is not excited from the outside.

The invention will be understood better upon reading the following description and examining the accompanying figures. These figures are given only by way of entirely non-limiting illustration of the invention.

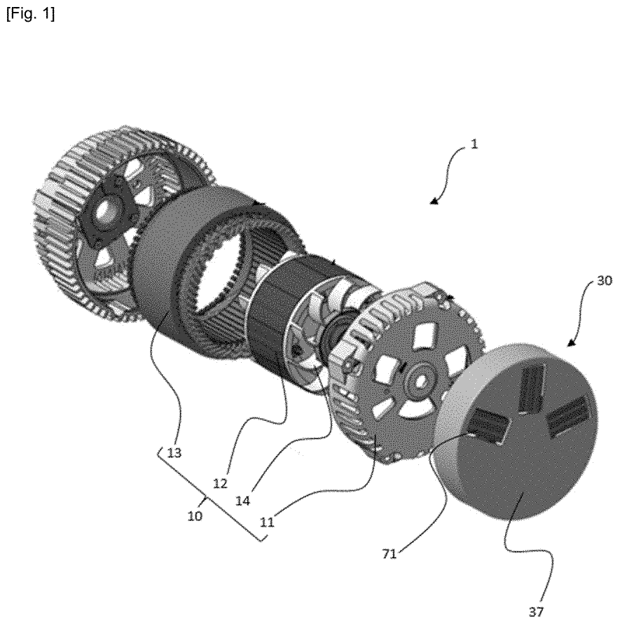

FIG. 1 shows a perspective view of an assembly according to a first embodiment of the present invention.

FIG. 2 shows a view in longitudinal section of an example of a rotary electric machine that can be used in the assembly in FIG. 1.

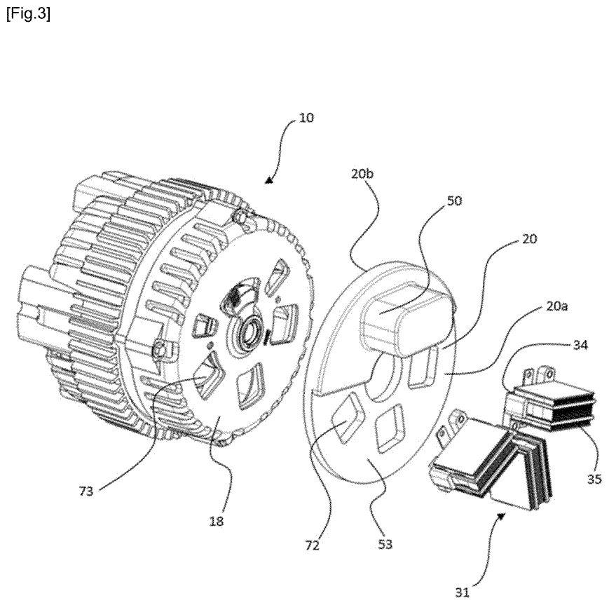

FIG. 3 shows an exploded view of the assembly in FIG. 1.

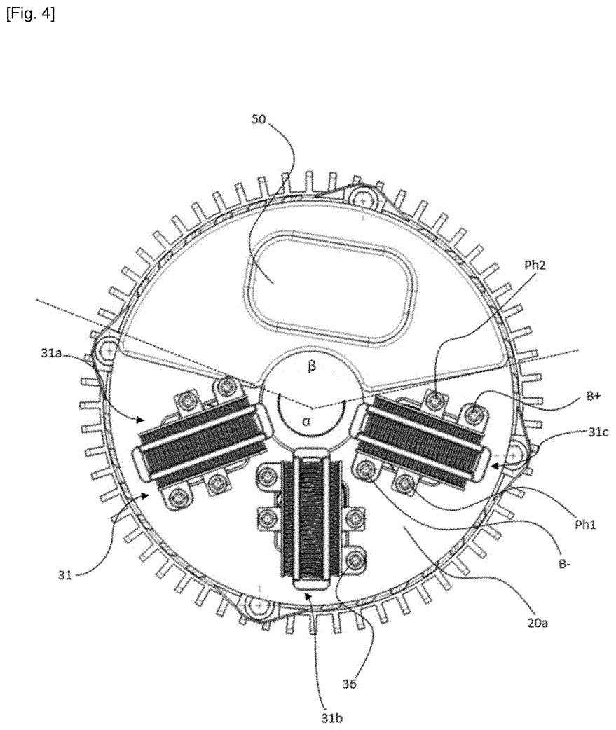

FIG. 4 shows a top view of the rear part of the assembly in FIG. 3.

FIG. 5 shows a perspective view of a part of the power module that can be seen in FIG. 3.

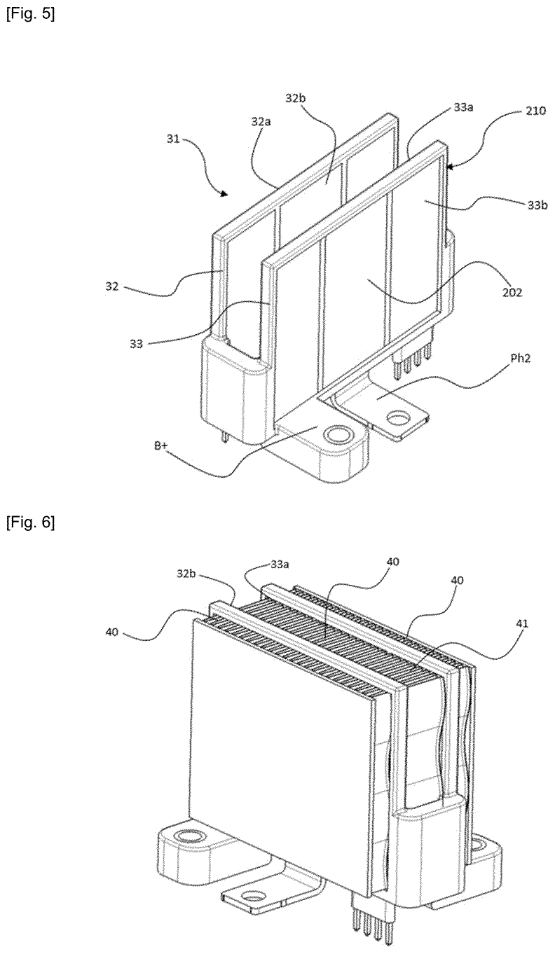

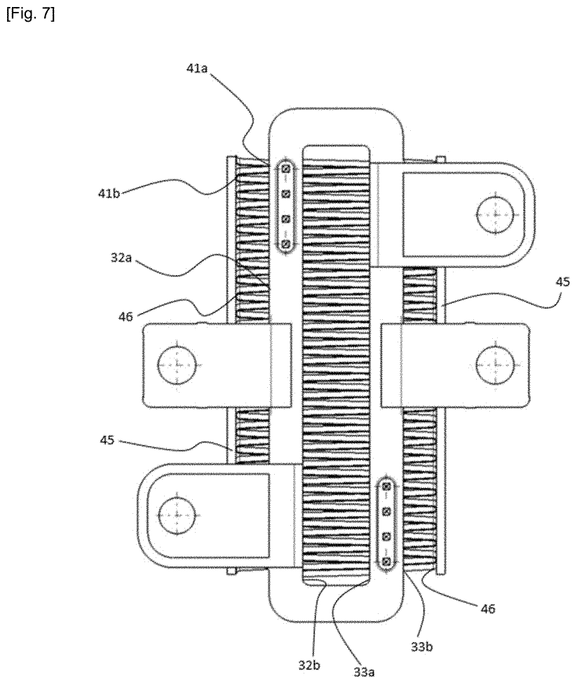

FIG. 6 shows a perspective view of the power module that can be seen in FIG. 3.

FIG. 7 shows a bottom view of the power module that can be seen in FIG. 3.

Identical, similar or analogous elements retain the same references from one figure to another.

FIG. 1 shows an assembly 1 which may be integrated into a drive architecture of a motor vehicle, in particular a low-power vehicle or hybrid vehicle. The assembly 1 that can be seen in FIG. 1 has a rotary electric machine 10 and an inverter 30 electrically connected to the electric machine 10. Advantageously, the inverter 30 is disposed on a rear end face of the rotary electric machine 10.

FIG. 2 shows in more detail an example of a rotary electric machine 10 that can be used in the assembly 1. The electric machine 10 has a polyphase stator 11 surrounding a rotor 12 of axis X mounted on a shaft 13. The stator 11 of the machine 10 surrounds the rotor 12, there being an air gap between the internal periphery of the stator 11 and the external periphery of the rotor 12. The stator 11 is carried by a casing 14 provided with a front bearing 17 and a rear bearing 18. The bearings 17 and 18 each have a rolling bearing 15 for rotationally mounting the shaft 13 with respect to the casing 14 of the electric machine 10. Preferably, the bearings 17, 18 are made of steel or aluminium.

The electric machine 10 is assembled from the rear by means of fixing tie rods for holding the assembly of the bearings 17 and 18, the stator 11 and the rotor 12. Use is preferably made of four tie rods spaced apart in pairs at an angle of 90 degrees plus or minus 10 degrees, as shown in FIGS. 3 and 4. One of the bearings 17 or 18 could also have lugs for fixing to an element of a gearbox or to another element of the motor vehicle.

The rotor 12—bearings 17 and 18—fixing tie rods assembly is mounted from one and the same side of the electric machine 10 (from the rear to the front). A simplified, standard and automated mounting method can thus be implemented.

The shaft 13 is equipped with splines that are straight, helical or smooth with clamping for coupling to a gearbox or an axle differential of a motor vehicle.

This assembly 1 could be intended to be coupled to a gearbox belonging to a motor vehicle drive train. The assembly 1 is thus able to operate in an alternator mode to supply in particular energy to the battery and to the on-board network of the vehicle, and in a motor mode, not only to start the combustion engine of the vehicle but also to provide motive power to the vehicle, on its own or in combination with the combustion engine. The power of the machine 10 may be between 4 kW and 50 kW. Alternatively, the electric machine 10 may be installed on an axle of the motor vehicle, in particular a rear axle.

In the example in question, the electric machine 10 advantageously exhibits an operating voltage less than 60 volts, preferably being 48 volts. Typically, the torque supplied by the electric machine is between 30 N.m and 150 N.m.

The rotary electric machine 10 is advantageously of the reversible type, meaning that it is able to operate in a motor mode for applying a motor torque to the wheels from the electrical energy of the battery, and in a generator mode for recharging a battery from a mechanical power picked up at the wheels.

More specifically, the rotor 12 has a body 12a in the form of a pack of laminations for reducing eddy currents. Permanent magnets are installed in openings in the body 12a. The magnets may be installed in a V-shaped configuration. Alternatively, the magnets are installed radially inside the cavities, the facing faces of two adjacent magnets having the same polarity. This is then a flux concentration configuration. The magnets may be made of rare earth or ferrite depending on the applications and the desired power of the machine 10. In a variant, the rotor may comprise only permanent magnets for creating a magnetic flux and may not be excited from the outside. Alternatively, the poles of the rotor 12 may be formed by coils.

Moreover, the rotor 12 has two flanges 22 each pressed against an axial end face of the rotor 12. These flanges 22 axially retain the magnets inside the cavities and also serve to balance the rotor 12. A spring may also be inserted inside each cavity in order to radially keep the magnets inside the cavities.

Furthermore, the stator 11 has a body 11a made up of a pack of laminations, and a winding 21. The body 11a is formed by a stack of laminations that are independent of one another and held in the form of a pack by means of a suitable fixing system. The pack of laminations is provided with slots, for example of the semi-closed type, equipped with a slot insulator for mounting the winding 21 of the stator 11. The body 11a is provided with teeth that delimit, in pairs, slots for mounting the winding 21 of the stator 11.

The winding 21 has a plurality of phase inputs/outputs 48 that pass through the slots in the body 11a of the stator and form bundles 25 that protrude on either side of the body 11a of the stator 11. The phase inputs and outputs 48 each comprise two ends and are obtained here from conductive elements in the form of pins that are connected together for example by welding. These windings are for example three-phase windings that are star- or delta-connected.

In the example in question, these phases 48 are connected to the inverter 30 via an interconnector 20. The inverter supplies the stator 11 with a polyphase current system. The interconnector 20 is fixed to a face of the rear bearing 18 that faces towards the outside of the electric machine 10. The interconnector 20 therefore has a first face 20a oriented away from the electric machine 10 and a second face 20b on the opposite side from said first face 20a and oriented towards the rear bearing 18. It will be possible to provide indexing means for ensuring that the interconnector 20 is positioned correctly with respect to the bearing 18, in particular to ensure the plurality of phase inputs/outputs 48.

The means for fixing the interconnector 20 to the bearing 18 (these not being visible in the figures) may consist of fixing members, such as screws, passing through fixing holes made in the interconnector and coinciding with tapped holes made in the rear bearing 18.

The interconnector 20 comprises tracks B+ and B− (not visible in the figures) which are overmoulded in particular in an overmoulding body 53. The body 53 is made advantageously of an insulating material, in particular of plastic. The body 53 has an annular shape substantially coaxial with the shaft 13.

As can be seen in FIGS. 3 and 4, the inverter 30 is electrically connected to the electric machine 10 via the interconnector 20. The inverter 30 has a plurality of power modules 31 and an electronic module 50 for controlling the plurality of power modules 31.

In the example in question, the inverter 30 comprises three power modules 31, the latter being connected to the phases 48 of the winding 21 of the stator. In the scope of the present invention, the power modules 31 are fixed to the first face 20a of the interconnector perpendicularly to the latter. Each power module comprises a first end 34, also known as the front end, which faces the first face 20a of the interconnector 20 to which it is fixed, and a second end 35, also known as the rear end, on the opposite side from the first end and not having any electrical connection. Each power module 31 therefore extends between its first and second ends 34, 35 in a plane perpendicular to the plane in which the interconnector 20 is located.

The power modules 31 are all concentrated over an angular portion α of the interconnector 20, said predefined portion a being less than 360°, preferably less than 220°.

Moreover, the interconnector 20 has a predefined angular portion β that is able to receive said electronic control module 50, said angular portion β being equal to 360°-α. The electronic control module conveys the low-voltage control signals, such as signals relating to the angular position of the rotor that are output for example by a Hall effect sensor or temperature signals that are output for example by a sensor integrated into the stator of the electric machine 10. Since the control components are known to those skilled in the art, they are not described in detail in the rest of the description.

As illustrated in FIGS. 4 and 5, each power module 31 has:
a first wall 32 having a first and a second lateral face 32a, 32b;
a second wall 33 having a first and a second lateral face 33a, 33b;
a conductive support 210 integrating four power tracks, namely a track B+, a track B− and two phase tracks Ph1, Ph2;
a plurality of electronic power switches 202 mounted on visible power tracks; and
a control circuit integrating signal components and integrated into the support.

Advantageously, each power module 31 comprises two walls 32, 33, each having a first and a second lateral face 32a, 32b, 33a, 33b. Advantageously, the two walls 32, 33 of one and the same power module are parallel to one another.

The electronic power switches 202 and the signal components are mounted on the conductive support 210. In one non-limiting example, the electronic switches are is transistors of the MOSFET type having low thermal resistance and preferably based on gallium nitride (GaN).

In the example illustrated, the power module 31 has four fixing orifices which receive the fixing means 36, which are fixing screws in one non-limiting example.

It will be noted that the fixing screws 36 not only make it possible to mechanically retain the power modules 31 on the interconnector 20 but also to provide an electrical connection between the power modules 31 and the interconnector 20.

In the example in question, the plurality of power modules 31 are distributed in three groups 31a, 31b, 31c, each group being fixed to the first face 21 of the interconnector 20 independently of the other groups. Each power module 31 may thus be easily mounted on and removed from the interconnector 20 to which it is fixed via the fixing screws 36. It is thus possible to remove one or more defective power modules 31 without damaging the rest of the inverter 30 or the rotary electric machine 10.

It will furthermore be noted that the welds of phases that are generally present in the prior art have been replaced by mechanical means which provide an electronic connection function since it is no longer necessary to have specific access to said phases to produce a weld.

Thus, in one non-limiting embodiment, the assembly 1 may have as many power modules 31 as necessary (at most two phases per module) in order to produce a machine having three, five, six or seven phases. Several power modules 31 may be grouped together in a group 31a, 31b, 31c. It is possible for example to have three groups each comprising two power modules 31.

In one non-limiting embodiment illustrated in FIG. 5, each power module 31 may have a ceramic comprising the control components (drivers) of the electronic switches, and the signal components. The electronic switches are attached to the conductive support by brazing and wire bonding. In this case, the power modules 31 also have a contour made of plastics material which allows all of the elements of the power module to be held together mechanically. In non-limiting embodiments, the plastics material of the contour is PEEK (polyether ether ketone) or PPA (polyphthalamide). These plastics are high-performance top-of-the-range plastics that can be used at high temperatures, for example around 350° C., this being advantageous during the brazing of the electronic switches to the conductive support.

In a variant, use may be made of a technology known as “copper inlay” for the power modules 31.

In operation, the temperature of the power modules 31 rises, as does the temperature at the active parts constituted by the stator and the rotor. It is necessary to cool the machine for it to operate properly. To this end, the electric machine 10 has means for generating a forced flow of a coolant 14 flowing in the axial direction of the machine, as can be seen in FIG. 1. In the example in question, the flow generating means 14 consist of a rear fan fixed to the rotor 12 or to the shaft 13, which draws air through the assembly 1.

Moreover, as can be seen in FIGS. 3, 4 and 6, a heat sink 40 for discharging heat from the power module is associated with each lateral face 32a, 32b, 33a, 33b of a power module. One and the same heat sink 40 may be associated with two lateral faces, it just being necessary to adapt its size. In the example in question, the heat sink 40 associated with the faces 32b and 33a is twice as large as the heat sinks 40 associated with a single face. Thus, since the heat sinks 40 are secured to the power modules 31 and not secured to the rear bearing 18, the cooling of the inverter is ensured irrespective of the heat produced by the rear bearing 18. The assembly 1 makes it possible to realize thermal decoupling between the rear bearing 18 and the inverter 30 such that the heat cannot propagate by conduction.

Preferably, each power module 31 comprises two walls 32, 33, each having a first and a second lateral face 32a, 32b, 33a, 33b and three heat sinks 40. A first heat sink 40 is associated with the first face 32a of the first wall 32, a second heat sink is associated with the second face 33b of the second wall 33, and a third heat sink is associated with the two lateral faces 32b, 33a.

Preferably, each heat sink 40 is made of a metal material such as aluminium. Each heat sink 40 has cooling fins 41 that extend perpendicularly to the interconnector 20. The fins 41 thus extend axially with respect to the axis of rotation X of the electric machine 10 between their first end 34 and their second end 35. Preferably, the fins 41 extend over the entirety of the lateral faces of the power modules 31. The fins 41 are advantageously in the form of strips and are wavy, of the sinusoidal type, thereby making it possible to increase the surface area for heat exchange with the air without otherwise increasing the space requirement of the heat sink 40 in an inconvenient manner.

As can be seen more clearly in FIG. 7, each of the heat sinks 40 has fins 41 that delimit an alternation of opposite arches 41a, 41b, these arches having substantially the same height.

A first series of arches 41a are connected to a lateral face 32a, 32b, 33a, 33b of a power module 31 and a second series of arches 41b opposite to the arches 41a of the first series and interposed between these arches 41a are connected to an opposite face.

In the example in question, a first series of arches 41a are connected to the lateral face 32b, and the second series of arches 41b are connected to the opposite lateral face 33a (or vice versa).

Two other first series of arches 41a are connected to the lateral faces 32a and 33b while the two other second series of arches 41b are connected to opposite faces 46 of two metal plates 45.

The two faces between which a heat sink 40 is fixed, namely 46 and 32a, 32b and 33a, 33b and 46 are substantially parallel to one another and define two parallel contact planes flush with the tops of the arches 41a, 41b.

Preferably, the heat sink 40 is fixed to each lateral wall of the power module 31 by pressure via a contact material having good thermal conductivity. The contact material is deformable at the time of assembly in order that it attaches itself to the two surfaces to be brought into contact, namely that of the power module on one side and that of the heat sink on the other side. This material may also compensate for any irregularities that might be present, for example beads or electrically conductive particles located between the two surfaces that come into contact during assembly.

It is essential for there to be excellent uniform thermal contact at least over the entire contact area between the power module and the heat sink. Use is preferably made of a plastically deformable paste, known for example as a gap filling paste, which also has the advantage of having good electrical insulation properties, as the contact material.

In a variant, the heat sink 40 may be welded to the power module 31 with or without addition of material. An example of welding without addition of material is ultrasonic welding and an example with addition of material may be brazing.

The fins 41 form axially oriented channels through which the axial flow of coolant passes, resulting in cooling by convection of the power modules 31.

As can be seen in FIGS. 1 and 3, the inverter 30 comprises a protective cover 37 comprising openings 71, the interconnector 20 comprises openings 72 and the rear bearing 18 comprises openings 73. The openings 71, 72, 73 extend perpendicularly to the axis X and are substantially aligned with one another for the passage of the axial flow of coolant.

In this way, the coolant, in particular the air, generated by the means 14 for generating a forced flow is introduced into the rear of the electric machine 10 at the openings 71 and then circulates in the axially oriented channels formed by the fins 41, cooling the power modules 31 before passing through the openings 72, 73. In the example in question, the fluid is discharged through apertures made in the rear bearing 18.

Of course, the above description has been given only by way of example and does not limit the field of the invention, which would not be departed from by replacing the various elements with any other equivalents.

Moreover, the different features, variants and/or embodiments of the present invention may be combined with one another in various combinations, as long as they are not mutually incompatible or mutually exclusive.

1. Assembly, in particular for a hybrid vehicle, comprising:
a rotary electric machine having:
means for generating a forced flow of a coolant flowing in the axial direction of the machine,
a rotor centred on and fixed to a rotary shaft extending along an axis,
a stator that surrounds the rotor and is provided with a body and at least one winding having a plurality of phase inputs/outputs, and
a rear bearing that is mounted at one end of the rotor and receives the shaft,
an inverter electrically connected to the rotary electric machine, having:
a plurality of power modules, each power module comprising a wall with a first and a second lateral face,
a heat sink having fins associated with each of said lateral faces, and
an electronic module for controlling the plurality of power modules,
an interconnector configured to connect the phases of the winding of the stator to the plurality of power modules and to connect the latter to the electronic control module, the interconnector having both a first face to which the plurality of power modules are fixed perpendicularly with respect thereto and a second face that is on the opposite side from said first face and oriented towards the rear bearing,
characterized in that the power modules are all concentrated over an angular portion (α) of the interconnector, said predefined portion (α) being less than 360°, preferably less than 220°.

2. Assembly according to claim 1, wherein the first face of the interconnector has a predefined angular portion (β) that is able to receive said electronic control module, said angular portion (β) being equal to 360°-α.

3. Assembly according to claim 1, wherein the plurality of power modules are distributed in at least two groups, each group being fixed to the first face of the interconnector independently of the other groups.

4. Assembly according to claim 1, wherein each power module comprises a first end which faces the first face of the interconnector to which it is fixed and a second end on the opposite side to said first end, said second end not having any connection.

5. Assembly according to claim 1, wherein the plurality of power modules are fixed to the first face of the interconnector via fixing means which also serve for the electrical connection between the power modules and the interconnector.

6. Assembly according to claim 1, wherein the interconnector comprises overmoulded tracks B+ and B−.

7. Assembly according to claim 6, wherein the plurality of power modules are connected to the tracks B+ and/or B− by the first face of the interconnector.

8. Assembly according to claim 1, wherein the fins form axially oriented channels through which the axial flow of coolant passes.

9. Assembly according to claim 1, wherein the interconnector comprises openings which extend perpendicularly to the axis for the passage of the axial flow of coolant.

10. Assembly according to claim 9, wherein the rear bearing comprises openings which extend perpendicularly to the axis (X) for the passage of the axial flow of coolant, said openings being substantially aligned with the openings in the interconnector.

11. Assembly according to claim 2, wherein the plurality of power modules are distributed in at least two groups, each group being fixed to the first face of the interconnector independently of the other groups.

12. Assembly according to claim 2, wherein each power module comprises a first end which faces the first face of the interconnector to which it is fixed and a second end on the opposite side to said first end, said second end not having any connection.

13. Assembly according to claim 2, wherein the plurality of power modules are fixed to the first face of the interconnector via fixing means which also serve for the electrical connection between the power modules and the interconnector.

14. Assembly according to claim 2, wherein the interconnector comprises overmoulded tracks B+ and B−.

15. Assembly according to claim 2, wherein the fins form axially oriented channels through which the axial flow of coolant passes.

16. Assembly according to claim 2, wherein the interconnector comprises openings which extend perpendicularly to the axis for the passage of the axial flow of coolant.

17. Assembly according to claim 3, wherein each power module comprises a first end which faces the first face of the interconnector to which it is fixed and a second end on the opposite side to said first end, said second end not having any connection.

18. Assembly according to claim 3, wherein the plurality of power modules are fixed to the first face of the interconnector via fixing means which also serve for the electrical connection between the power modules and the interconnector.

19. Assembly according to claim 3, wherein the interconnector comprises overmoulded tracks B+ and B−.

20. Assembly according to claim 3, wherein the fins form axially oriented channels through which the axial flow of coolant passes.
